(19) United States
(12) Patent Application Publication
(10) Pub. No.: US 2009/0123259 A1
(43) Pub. Date: May 14, 2009

(54) Removable vehicle transport rack

(76) Inventor: Britt Barclay, Bend, OR (US)

Correspondence Address: Thomas M. Spear, Jr., P.O. Box 1274, Bend, OR, 97709-1274, US

(21) Appl. No.: 11/453,555

(22) Filed: Jun. 14, 2006

(51) Int. Cl. B60P 9/00; B65G 69/30

(52) U.S. Cl. 414/462; 14/71.1

(57) ABSTRACT

A removable vehicle transport rack that attaches to a pickup or similar transport vehicle and provides the user with a means to transport or haul small vehicles like an all-terrain vehicle (ATV) or motorcycle. The rack uses a stinger extending from the transport vehicle hitch and then a removable deck that has pivoting center member which allows the deck to fold and unfold and thereby allowing ATVs or motorcycles to go up or down the deck's tracks. The tracks pivot or unfold to load ATVs and then fold, partially, once the ATV is in place and is secured. The user is able to take advantage of the extra length to load additional ATVs or other material where in the past one ATVs would occupy the whole of the transport vehicle's bed.

### CROSS REFERENCE TO RELATED APPLICATION

None.

### BACKGROUND OF THE INVENTION

This invention relates to transporting small vehicles, and in particular to a carrier that can be mounted on a pickup truck to carry an all terrain vehicle (ATV).

There are many recreational ATV users that must routinely transport their ATV's to different locations. Often users will transport the ATVs on a trailer or in the bed of a pickup truck. Either method of transport works well, but each has its limitations. A pickup bed is limited in size and can usually hold a single ATV. A trailer can carry two or more ATV's, but a truck and trailer combination is larger and more difficult to maneuver. A need therefore exists for an ATV carrier that can increase the carrying capacity of a pickup truck and avoid the need for a trailer when transporting more than one ATV.

### SUMMARY OF THE INVENTION

A frame for supporting and transporting a vehicle comprising: a first elongate member having a first end portion and a pivotable second portion, the pivotable second portion having a first extended position wherein it is supported on an underlying surface, and a second retracted position wherein it is disposed at an upward angle relative to the first end portion; a connector mounted on the first elongate member first end and adapted for being mounted on a tail gate of a transport vehicle; and, a support member having a first end adapted for insertion into a vehicle trailer hitch, and having a second end connected to the first elongate member.

### BRIEF DESCRIPTION OF THE DRAWINGS

FIG. 1a is a perspective view of the removable vehicle transport rack (RVTR) or rack when the rack is folded and unattached to a transport vehicle. The stinger stanchion is shown with a wheel 37 attached for easy hauling. Tailgate support members 22 are in located at the top of the folded unit.

FIG. 1b. is a perspective view of the RVTO's stinger attached to a transport vehicle.

FIG. 2a is perspective view of the RVTR attached to the transport vehicle—the rack is still folded.

FIG. 2b is a perspective view of the RVTR with the rack in the half open position showing the set of two tracks being unfolded.

FIG. 2c is a perspective view of the RVTR in the unfolded position ready to have an ATV drive up the pair of tracks.

FIG. 3 perspective view of the RVTR showing one track in a transport mode—track is partially folded to the ATV and the other track is still unfolded.

### DETAILED DESCRIPTION

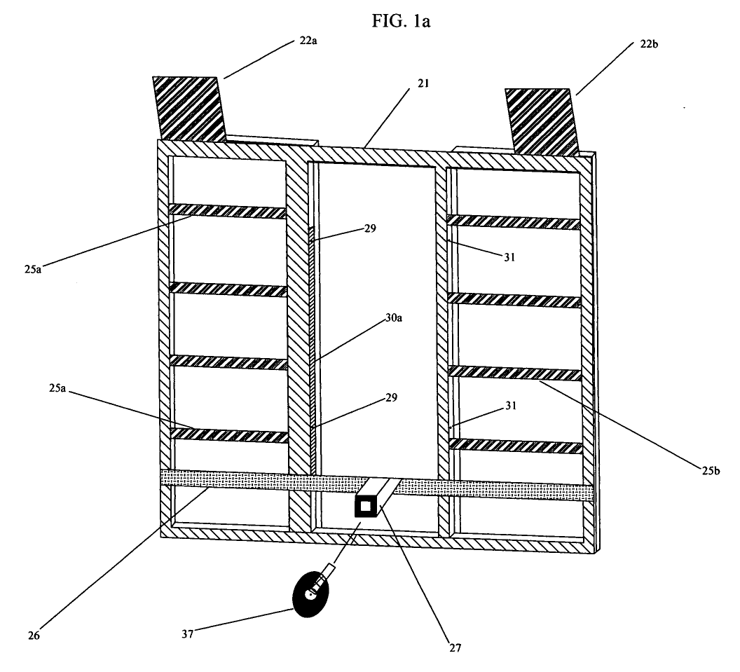

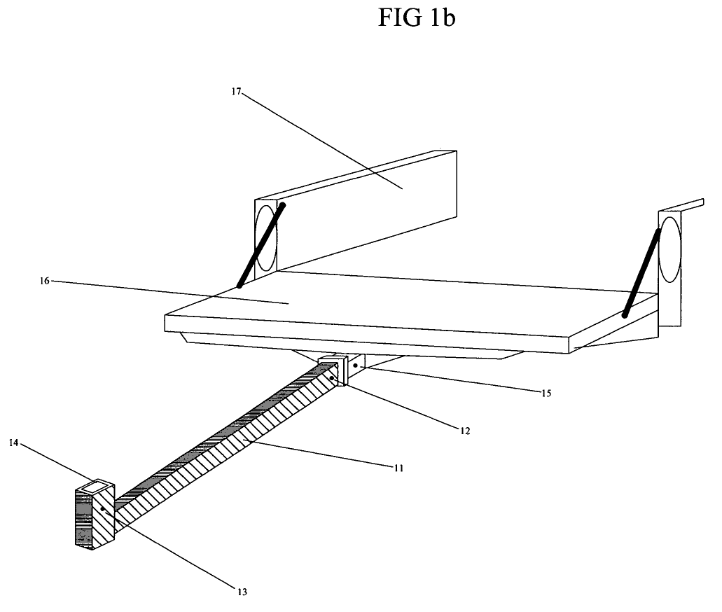

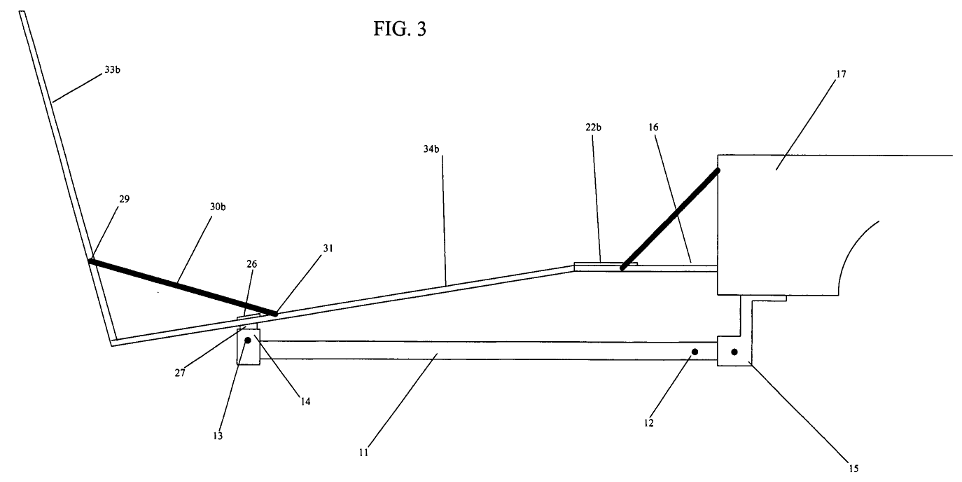

Referring now to the drawings, a removable vehicle transport rack (RVTR or rack) according to a preferred embodiment of the invention is shown generally in FIG. 3. Referring to FIGS. 1a and 1b, the RVTR 10 includes a deck 20 that has pair of segmented tracks 25a and 25b that are attached to the tailgate 16 of a pickup truck or transport vehicle. In the preferred embodiment tracks 25a and 25b are space frame members for the best combination of strength and lightness, although the invention is not limited to any particular material or specific design of track. FIG. 1a depicts the RVTR in a folded mode with a wheel 37 inserted into a piece of hollow metal called stinger stanchion 27. The stinger stanchion is the support piece connecting the deck to the stinger 11, FIG. 1b.

In the preferred embodiment, the frame and the associated material are made from steel and the pieces are generally welded together. Other materials, such as aluminum, titanium, or other material known for their strength and toughness can be used for the components of the RTVR. There are several means known to those skilled in the art for connecting the various pieces of the RTVR and the description contained herein is not meant to limit the scope of the claims: other means, besides welding, for connecting the various pieces include; riveting, gluing, bolting, nailing, screwing, or other similar means. Generally, the size and weight of the material used in the manufacture will depend on the type of load or ATVs that are to be transported and carried by the RVTR.

It should also be pointed out that pieces of the RVTR that are not welded together are made such that an operator can dissemble and assemble as needed. This modularity makes it easier for the operator to package, transport or store the RVTR.

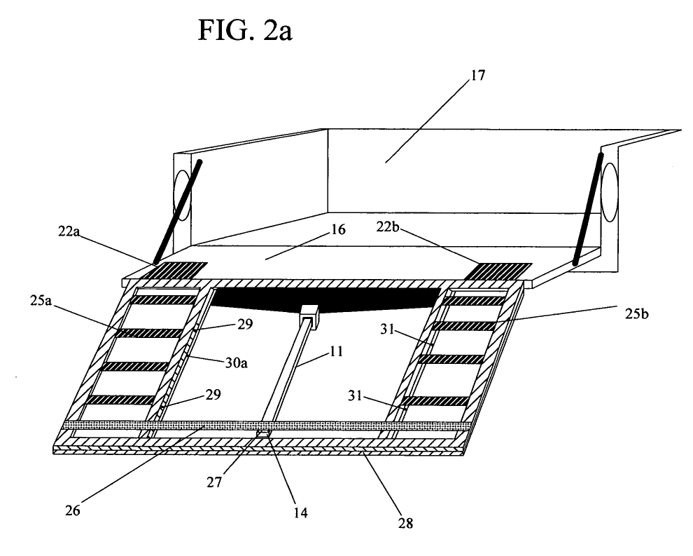

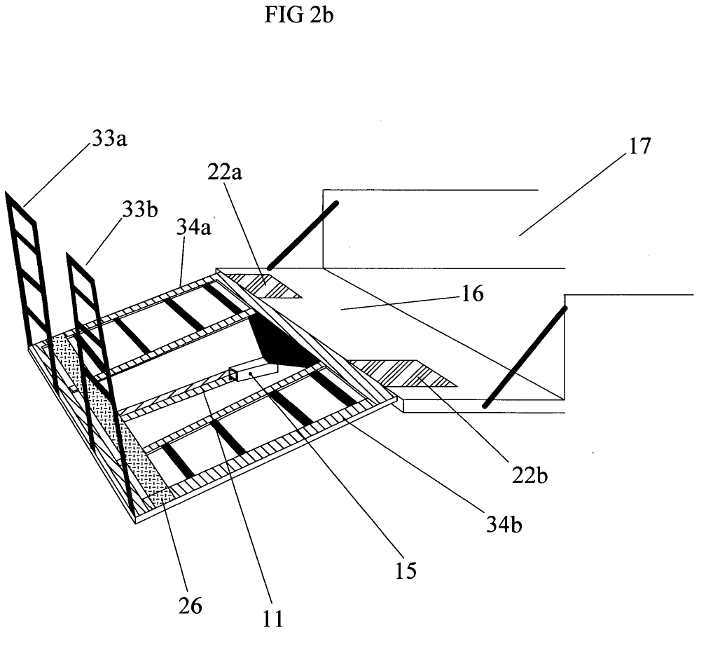

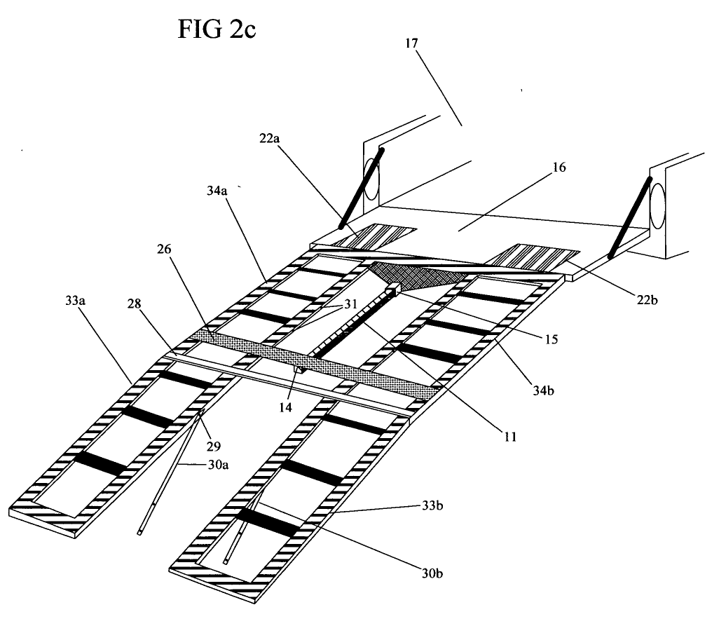

Referring to FIGS. 2a and 2b and 2c, a deck 20 made from tracks 25a and 25b are segmented to form a front portion 34a and 34b and a rear pivoting portion 33a and 33b. The front and rear portions are connected by a transverse hinge member 28. The segmented tracks are attached to the transverse hinge member such that the segmented tracks fold and unfold at along hinge member 28.

Tracks 25a and 25b are connected together by transverse support member 21, FIG. 1a, on the front end of the forward track segments 34a and 34b. The front portion 34a and 34b of each track 25a and 25b is mounted or set on the pickup tailgate 16 by respective tailgate ramp supports 22a and 22b. The tailgate ramp support members 22a and 22b are attached to the transverse support member 21 by welding, bolting, riveting, pinning or other means known to those skilled in the art. When the RTVR is attached, the tailgate ramp support members will sit or rest on the end of the transport vehicle's tailgate as depicted in FIGS. 2a, 2b and 2c.

To use the RVTR, refer to FIG. 1b, an operator inserts a longitudinal support or stinger 11 into a hitch 15 of a pickup truck or transport vehicle 17. The stinger 11 extends rearward and ends in a receiver 14. The stinger is attached to the transport vehicle at the hitch 15 by a pin and hole arrangement commonly used on vehicle hitches. The stinger is inserted into the hitch and holes located on the stinger 12 and the hitch are aligned and a pin is placed in the holes to secure the stinger to the transport vehicle.

On the deck, a stinger stanchion 27 is connected to a transverse stanchion support member 26 just forward of the hinge frame member 28 in each track and on the underside of the tracks 25a and 25b. The stanchion support member 26 is connected to the outer and underside of the front portions of track 34a and 34b. The transverse stanchion support member 26 extends from the outer frame of one track 34a extending to the outer frame of the other 34b. Attached to and projecting downward from the stanchion support member is an angled connecting bracket 26a.

In the preferred embodiments the angle in which the connecting bracket 26a is attached to the transverse stanchion support member is adjustable to accommodate differences in ground height and differences in various transport vehicles tailgate or hitch heights. In one preferred embodiment each track is 7 (seven) feet long, 12 (twelve) to 18 (eighteen) inches wide, and is hinged in the middle, although the invention is not limited to any particular dimension. It should be noted that a segmented track of seven feet means that the tracks when fully open at the hinge member 28 will have a length of fourteen feet.

The operator attaches rack 10 to the pickup truck by first mounting the stinger 11 in the transport vehicle hitch. The stinger is secured by a pin placed through the hitch hole 12. The stinger stanchion 27 of the deck is placed into the receiver 14 of the stinger 11 such that the tailgate support members 22a and 22b rest upon the tailgate 16 of the transport vehicle. The stinger stanchion is secured to the receiver by a pin and hole arrangement similar to the stinger and hitch arrangement: hole in the stanchion and receiver are lined up and a pin is used to secure the deck to the stinger. Other means for connecting or mounting the deck to the stinger can be deployed and are known to those skilled in the art and this particular embodiment in no way limits the scope of the claims made.

When the tailgate ramp supports 22a and 22b are resting on the tailgate. Each rear pivoting portion 33a and 33b is then rotated to place its distal end on the ground, and hinge member 28 is locked into place to provide a rigid track. Prior to rotating or unfolding the rear tracks 33a and 33b from the front track 34a and 34b, see FIG. 2b, a set of locking pins 29 is removed from holes located on the inner tracks of 33a, 33b, 34a and 34b. The tracks are pinned together in the folded mode of operation and when the pins are removed, the rear tracks are able to unfold. The pins 29 and holes 31 located on the inner side of the inside tracks and are used to position and lock the rear tracks with respect to the forward tracks at specified locations using a set of flat bars 30a and 30b, see FIGS. 2c and 3. Initially, to load ATVs the rear rack is unfolded until the rear sections touch the ground.

An ATV is then rolled up along tracks 25a and 25b until its front wheel rest on the tailgate. The ATV needs to be placed forward of hinge member 28 in order for the rear tracks 33a and 33b to be rotated forward for a partially folding of the tracks, see FIG. 3. Straps or cables are then attached to the ATV and the transport vehicle to secure the ATV into place. Depending on the size of the transport vehicle and the size of the ATV, it is possible to load an ATV or two or other items into the bed of the transport vehicle prior to placing the ATV in the location described above. This invention provides the operator with the extended length of the deck for loading additional items onto the transport vehicle and is one of the objects of this invention.

Once the ATV is secured in place the rear tracks 33a and 33b are rotated up and forward to a position at which the flat bars 30a and 30b can be pinned fixing the rear tracks with respect to the forward tracks 34a and 34b. To accomplish this, holes 31 located on the inside section of the rear and forward tracks are aligned with holes on either end of the flat bars. A pin is placed into the flat bar and then the inside section of the track. The number and placement of the holes in the inside section of the tracks will provide the operator with the various places at which the rear track members can be fixed with respect to the forward track members.

Once the flat bars are pinned to the rear and forward track members, the rear track members 33a and 33b provide an additional barrier for the ATV to roll off the back of the transport vehicle, thus preventing the ATV from rolling off the back if the straps or cables break or become undone. The ATV is then supported in the front by the bed of the pickup and in the rear by tracks 33a and 33b.

In other embodiments of the invention a single track can be used to support a motorcycle in a similar manner, or two motorcycles can be transported on the embodiment illustrated, one on each track.

While the invention has been described by reference to preferred embodiments, those of skill in the art will appreciate that the preferred embodiments can be modified in detail and arrangement without departing from the scope of the invention.

I claim:

1. A frame for supporting and transporting a vehicle comprising: a first elongate member having a first end portion and a pivotable second portion, the pivotable second portion having a first extended position wherein it is supported on an underlying surface, and a second retracted position wherein it is disposed at an upward angle relative to the first end portion;
a connector mounted on the first elongate member first end and adapted for being mounted on a tail gate of a transport vehicle; and,
a support member having a first end adapted for insertion into a vehicle trailer hitch, and having a second end connected to the first elongate member.

2. A frame according to claim 1 further comprising the pivotable second portion being operable between the first and second positions.

3. A frame according to claim 1 further comprising the pivotable second portion being operable between the first and second positions.

4. A frame according to claim 1 further wherein the first elongate member defines a ramp surface extending between the underlying surface and the tail gate when the pivotable second portion is in the extended position.

5. A frame for supporting and transporting a vehicle comprising: a first elongate member having a first end portion and pivoting second portion, the pivoting second portion having a first extended position wherein it is supported on an underlying surface, and a second retracted position wherein it is disposed at an upward angle relative to the first end portion;
a first connector mounted on the first elongate member first end and adapted for being mounted on a tail gate of a transport vehicle;
a second elongate member adjacent to the first elongate member, the second elongate member having a first end portion and a pivoting second portion, the pivoting second portion having a first extended position wherein it is supported on an underlying surface, and a second retracted position wherein it is disposed at an upward angle relative to the first end portion;
a second connector mounted on the second elongate member first end and adapted for being mounted on a tail gate of a transport vehicle;
a transverse member extending between the first and second elongate members; and,
a support member having a first end adapted for insertion into a vehicle trailer hitch, and having a second end connected to the transverse member.
